(19) United States
(12) Patent Application Publication
(10) Pub. No.: US 2014/0192927 A1
(43) Pub. Date: Jul. 10, 2014

(54) METHOD AND APPARATUS FOR SELECTING MULTI-ANTENNA TRANSMISSION MODE IN ELECTRONIC DEVICE

(71) Applicant: Samsung Electronics Co., Ltd., Suwon-si (KR)

(72) Inventor: Jin KIM, Suwon-si (KR)

(73) Assignee: Samsung Electronics Co., Ltd., Suwon-si (KR)

(21) Appl. No.: 14/103,071

(22) Filed: Dec. 11, 2013

(30) Foreign Application Priority Data
Jan. 9, 2013 (KR) 10-2013-0002448

(51) Int. Cl. H04B 7/06

(52) U.S. Cl. CPC H04B 7/06
USPC 375/299

(57) ABSTRACT

A method for selecting a multi-antenna transmission mode of an electronic device is provided. The method includes determining, by using a detection signal from a sensor, whether there is a contact with a human body, changing a second transmission mode to a first transmission mode when there is a contact with a human body that affects the electromagnetic field around an antenna, and transmitting the same data stream through at least two antennas according to the first transmission mode.

### CROSS-REFERENCE TO RELATED APPLICATION(S)

This application claims the benefit under 35 U.S.C. §119(a) of a Korean patent application filed on Jan. 9, 2013 in the Korean Intellectual Property Office and assigned Serial No. 10-2013-0002448, the entire disclosure of which is hereby incorporated by reference.

### TECHNICAL FIELD

The present disclosure relates to an electronic device. More particularly, the present disclosure relates to a method and an apparatus for selecting a multi-antenna transmission mode in an electronic device.

### BACKGROUND

Due to a rapid growth of a wireless mobile communication market, various multimedia services under a wireless environment are being needed, and in particular, the volume of data transmission becomes large and data is being transmitted at a high speed. Thus, a study on building, by using limited radio resources, a communication system that has high speed and reliability, such as a maximum data rate and a minimum error rate, is being conducted. In order to build the communication system that has the high speed and reliability, a new transmission technology using multiple antennas is needed and as an example, a Multiple Input Multiple Output (MIMO) system using multiple antennas is being used. The MIMO system is a system of which the transmitting and receiving ends each use multiple antennas, and an active study on that is recently conducted because the MIMO system may increase a channel transmission capacity in proportion to the number of antennas even without further frequency or transmit power assignment as compared to a single antenna system.

The multi-antenna technologies may be roughly divided into a spatial diversity scheme that enhances transmission reliability by obtaining a diversity gain corresponding to the product of the numbers of transmitting and receiving antennas, a Spatial Multiplexing (SM) scheme that increases a bit rate by simultaneously transmitting rows of signals, and a scheme that is a combination of the spatial diversity and spatial multiplexing.

The spatial diversity scheme may have a diversity effect of being proportional to the product of the number of transmitting antennas and the number of receiving antennas by using Space Time Block Coding (STBC). Thus, it is possible to enhance reception performance.

In general, since each of the spatial diversity scheme and the spatial multiplexing scheme has advantages and disadvantages, these two schemes are combined. For example, the spatial multiplexing scheme is used in a strong magnetic field so as to enhance a transmission speed and the spatial diversity is used in a weak magnetic field so as to minimize a decrease in antenna efficiency and thus, prevent a decrease in system performance.

On the other hand, a portable terminal in addition to a base station is recently using multiple antennas, and in general, it has internal antennas at its upper and lower ends. Thus, when a user attempts to make a voice call or data communication, griping his/her terminal, antennas in the portable terminal are affected by how the user grips the terminal, in addition to a channel environment. For example, when the terminal is affected by a human body, the efficiency of the antenna corresponding to a contact part decreases even in a good magnetic field state and thus, there is a drawback that the entire transmission rate decreases.

Therefore, there is a need for a method and a device for minimizing a decrease in antenna efficiency caused when an electronic device is in contact with a human body.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and a device for selecting a multi-antenna transmission mode in consideration of how a user grips an electronic device.

Another aspect of the present disclosure is to provide a method and a device for selecting a multi-antenna transmission mode in consideration of a channel state and of how a user grips an electronic device.

Another aspect of the present disclosure is to provide a method and a device for minimizing a decrease in antenna efficiency by switching a spatial multiplexing scheme to a spatial diversity scheme when an electronic device is in contact with a human body.

In accordance with an aspect of the present disclosure, a method for selecting a multi-antenna transmission mode in an electronic device is provided. The method includes determining, by using a detection signal from a sensor, whether there is a contact with a human body that affects an electromagnetic field around an antenna, changing a second transmission mode to a first transmission mode if there is a contact with a human body that affects an electromagnetic field around an antenna, and transmitting a same data stream through two or more antennas according to the first transmission mode.

In accordance with another aspect of the present disclosure, a method of operating an electronic device is provided. The method includes determining, by using a detection signal from a sensor, whether there is a contact with a human body that affects an electromagnetic field around an antenna, selecting a first transmission mode if there is a contact with the human body that affects the electromagnetic field around the antenna, and selecting a second transmission mode if there is no contact with the human body that affects the electromagnetic field around the antenna, and transmitting a data stream through two or more antennas according to the first or second transmission mode.

In accordance with another aspect of the present disclosure, an electronic device is provided. The electronic device includes a sensor, one or more processors, a memory, and one or more programs stored in the memory and configured to be executed by the one or more processors, wherein the one or more programs comprise instructions to determine, by using a detection signal from a sensor, whether there is a contact with a human body that affects an electromagnetic field around an antenna, change a second transmission mode to a first transmission mode if there is a contact with the human body, and transmit a same data stream through two or more antennas according to the first transmission mode.

In accordance with another aspect of the present disclosure, an electronic device is provided. The electronic device includes a sensor, one or more processors, a memory, and one or more programs stored in the memory and configured to be executed by the one or more processors, wherein the one or more programs comprise instructions to determine, by using a detection signal from the sensor, whether there is a contact with a human body that affects an electromagnetic field around an antenna, select a first transmission mode if there is a contact with the human body that affects the electromagnetic field around the antenna and select a second transmission mode if there is no contact with the human body, and transmit a data stream through two or more antennas according to the first or second transmission mode.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIGS. 1A and 1B illustrate orientations of how a user grips an electronic device according to an embodiment of the present disclosure;

FIG. 2 is a flowchart for selecting a multi-antenna transmission mode in an electronic device according to an embodiment of the present disclosure;

FIGS. 3A and 3B are diagrams illustrating spatial diversity and spatial multiplexing according to an embodiment of the present disclosure;

FIG. 4 is a schematic block diagram of an electronic device according to an embodiment of the present disclosure; and

FIGS. 5A and 5B are schematic block diagrams of a communication processor according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

A method and a device for selecting a multi-antenna transmission mode in an electronic device according to the present disclosure will be described below.

In the following, antenna efficiency means the ratio of power radiated from an antenna to power supplied to the antenna, or means the ratio of radiant energy to supplied energy. The radiant energy is produced while a portion of power supplied to the antenna is consumed by the conductor resistance or ground resistance of the antenna and dielectric and the rest of the power is radiated to space as currents. The antenna efficiency is also referred to as radiation efficiency.

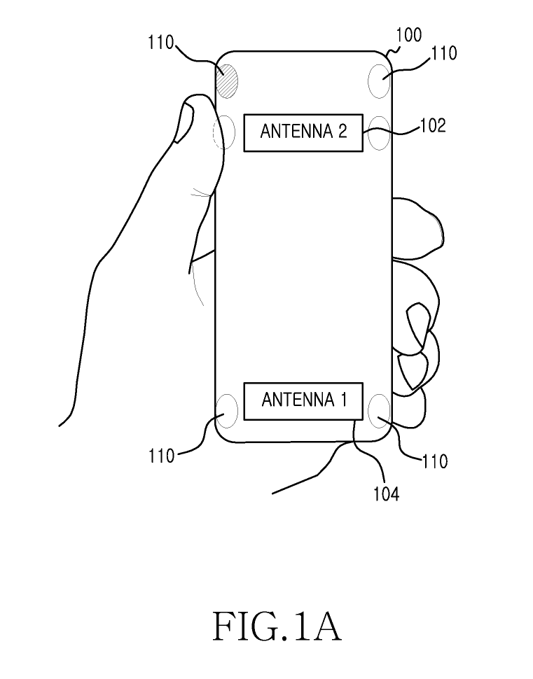

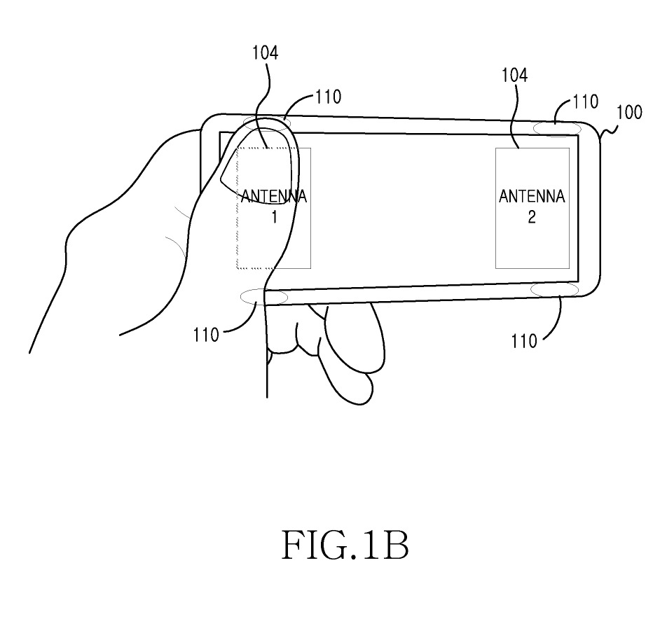

FIGS. 1A and 1B illustrate orientations of how a user grips an electronic device according to an embodiment of the present disclosure.

Referring to FIG. 1A, a user grips an electronic device, maintaining his/her hand horizontally. An electronic device 100 supports a Multiple Input Multiple Output (MIMO) technique that performs transmission and reception by using a plurality of antennas. The electronic device 100 may have two antennas, 102 and 104, for transmission and reception, and the transmitting and receiving antennas may be separated as internal antennas or integrated. Moreover, the two antennas 102 and 104 are isolated from each other so as to avoid interference. For example, a first antenna 104 of an internal type is located at the upper end of the electronic device 100, and a second antenna 102 of an internal type is located at the lower end of the electronic device 100.

Typically, when a user grips the electronic device, maintaining his/her grip horizontally, the user does not simultaneously cover two antennas 102 and 104 with his/her hand but he/she covers one of them with his/her hand. In this case, the antenna covered with a user's hand is affected by the user's hand and thus, its antenna efficiency may decrease as compared to another antenna that the user does not cover with his/her hand.

For example, when the user covers the lower part of the electronic device 100, the first antenna 104 experiences jamming due to the user's hand and thus, its antenna efficiency may decrease as compared to the second antenna 102 that the user does not cover.

The present disclosure determines by using a grip sensor 110 how a user grips an electronic device, and determines a transmission mode according to the result so as to minimize a decrease in antenna efficiency.

Referring to FIG. 1B, a user grips the electronic device 100, maintaining his/her hand vertically. Similarly, the electronic device 100 supports a MIMO technique that performs transmission and reception by using a plurality of antennas. The electronic device 100 may have two antennas, 102 and 104, for transmission and reception, and the transmitting and receiving antennas may be separated as internal antennas or integrated. Moreover, the two antennas 102 and 104 are isolated from each other so as to avoid interference. For example, a first antenna 104 of an internal type is located at the upper end of the electronic device 100, and a second antenna 102 of an internal type is located at the lower end of the electronic device 100.

Typically, when a user grips the electronic device, maintaining his/her grip vertically, the user does not simultaneously cover two antennas 102 and 104 with his/her hand but he/she covers one of them with his/her hand. In this case, the antenna covered with a user's hand is affected by the user's hand and thus, its antenna efficiency may decrease as compared to another antenna that the user does not cover with his/her hand.

For example, when the user covers the left part of the electronic device 100, the first antenna 104 experiences jamming due to the user's hand and thus, its antenna efficiency may decrease as compared to the second antenna 102 that the user does not cover.

The present disclosure determines by using the grip sensor 110 how a user grips the electronic device, and determines a transmission mode according to the result so as to minimize a decrease in antenna efficiency.

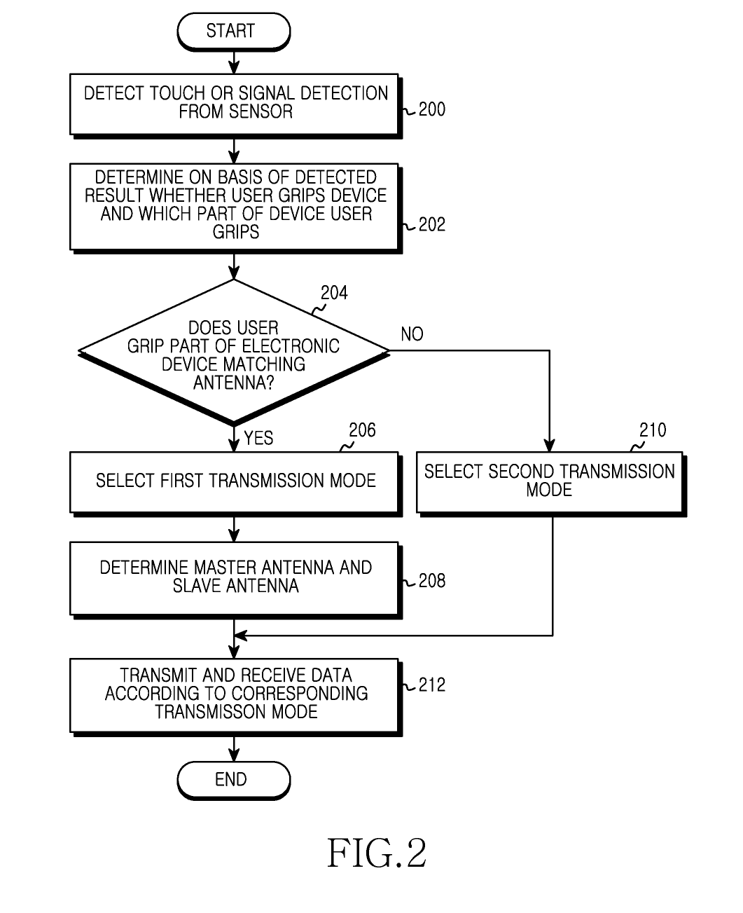

FIG. 2 is a flowchart for selecting a multi-antenna transmission mode in an electronic device according to an embodiment of the present disclosure.

Referring to FIG. 2, the electronic device detects a touch from a touch screen or a signal from a grip sensor so as to detect how a user grips the electronic device, at operation 200. Here, detecting how the user grips the electronic device may be performed through a change in pressure or in capacitance. More particularly, it is possible to detect a change in pressure by using at least one first sensor that is installed at the electronic device. The at least one first sensor that is installed at the electronic device may be defined as a grip sensor. More particularly, the grip sensor may include a resistive touch sensor, a C-type capacitive touch sensor, and a strain gauge sensor. Here, the resistive touch sensor may be defined as a sensor that may recognize coordinates for a change in resistance caused by a user input and detect a change in pressure. Moreover, the C-type capacitive touch sensor may be defined as a sensor that determines coordinates through a change in capacitance that is caused by a user input. Moreover, the strain gauge sensor may be defined as a sensor that may recognize a value in a sensor changed by pressure applied by a user and detect a change in pressure. For example, the electronic device may detect a change in pressure of the electronic device by using at least one grip sensor. For example, as shown in FIGS. 1A to 1B, it is possible to detect a change in pressure or capacitance of the electronic device by using at least one grip sensor 120 that is installed at a part of the electronic device while the electronic device is in a sleep mode.

According to another implementation, by using a proximity sensor instead of the grip sensor, it is possible to recognize how the user grips the electronic device. For example, when a user grips the electronic device with his/her hand, the proximity sensor detects the proximity of an object (such as a user's hand) and outputs a corresponding signal.

Subsequently, the electronic device determines, based on the detected result, whether a user grips the electronic device and which part of the electronic device the user grips, at operation 202. For example, the electronic device determines whether the user grips the upper or lower part of the electronic device. Alternatively, the electronic device determines whether the user grips the right or left part of the electronic device.

Subsequently, the electronic device determines whether the user grips a part of the electronic device matching or adjacent to an antenna at operation 204, and if positive, the electronic device proceeds to operation 206 to select a first transmission mode, and determines a master antenna and a slave antenna at operation 208.

For example, when there is an antenna that is affected by a human body, a first transmission mode in which the same data stream is transmitted through two antennas is selected, an antenna that is affected by a human body is set to a slave antenna, and an antenna that is not affected by a human body is set to a master antenna. Here, the master antenna may perform both transmission and reception and the slave antenna may perform transmission.

On the other hand, if the user does not grip a part of the electronic device matching or adjacent to an antenna, the electronic device proceeds to operation 210 to select a second transmission mode.

For example, when there is no antenna that is affected by a human body, a second transmission mode in which different data streams are transmitted through two antennas is selected.

Subsequently, the electronic device transmits and receives data according to a corresponding transmission mode at operation 212. For example, in the first transmission mode, the electronic device transmits the same data stream by using two antennas and in the second transmission mode, the electronic device transmits different data streams by using two antennas.

Subsequently, the procedures of the present disclosure will end.

In this way, when there is an antenna that is affected by a human body, a spatial diversity gain is considered by transmitting the same data stream through two antennas, and when there is no antenna that is affected by a human body, a spatial multiplexing gain is considered by transmitting different data streams through two antennas. Thus, it is possible to minimize a decrease in antenna efficiency.

Moreover, the electronic device receives a data stream with a master antenna excluding an antenna that is affected by a human body (a slave antenna) and thus, it is possible to minimize a decrease in entire antenna efficiency.

Although the present disclosure exemplifies two antennas, a first antenna and a second antenna, it is not limited thereto and may also be applied to a case where more antennas are included. Moreover, although FIG. 2 does not consider a channel environment, such as whether there is a weak magnetic field or a strong magnetic field, the present disclosure may apply a combination of the channel environment and a contact with a human body. For example, a transmission mode may be determined in consideration of an initial channel environment and changed according to a contact with a human body, or a transmission mode may be determined in consideration of an initial contact with a human body and changed according to a channel environment.

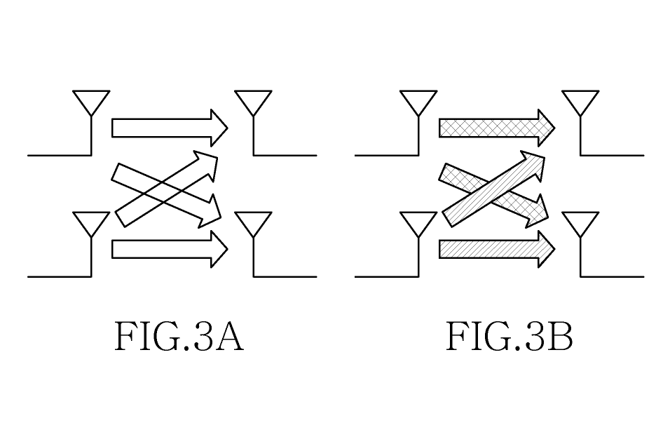

FIGS. 3A and 3B are diagrams illustrating spatial diversity and spatial multiplexing according to an embodiment of the present disclosure.

FIG. 3A illustrates a spatial diversity scheme and FIG. 3B illustrates a spatial multiplexing scheme.

Referring to FIGS. 3A and 3B, the spatial diversity scheme is a scheme in which redundant information is transmitted from a transmission terminal through a plurality of transmitting antennas and a reception terminal properly combines signals so as to improve data error. In the spatial diversity scheme, a space-time code may be used, such as a Space-Time Trellis Code (STTC) and a Space Time Block Code (STBC), or a transmit beamforming system may be used which returns channel state information from the reception terminals to the transmission terminals or uses uplink channel information that is estimated at the transmission terminals.

In the spatial multiplexing scheme, antennas of the transmission terminals are used to simultaneously send different data streams and antennas of the reception terminals are used to identify the transmitted streams. When the number of transmitting antennas is Nt and the number of receiving antennas is Nr, the reception terminal may identify each data stream and enhance data transmission rate Nt times without additional consumption of frequency resources, if the number of the receiving antennas is larger than that of the transmitting antennas.

In the case of the spatial multiplexing scheme, it is possible to transmit a lot of data due to an increase in transmission capacity but it has a significant transmission error rate. The spatial diversity scheme may not send a lot of information because there is no gain in transmission capacity, but it has an advantage in that it is possible to stably transmit data because a transmission error rate is low.

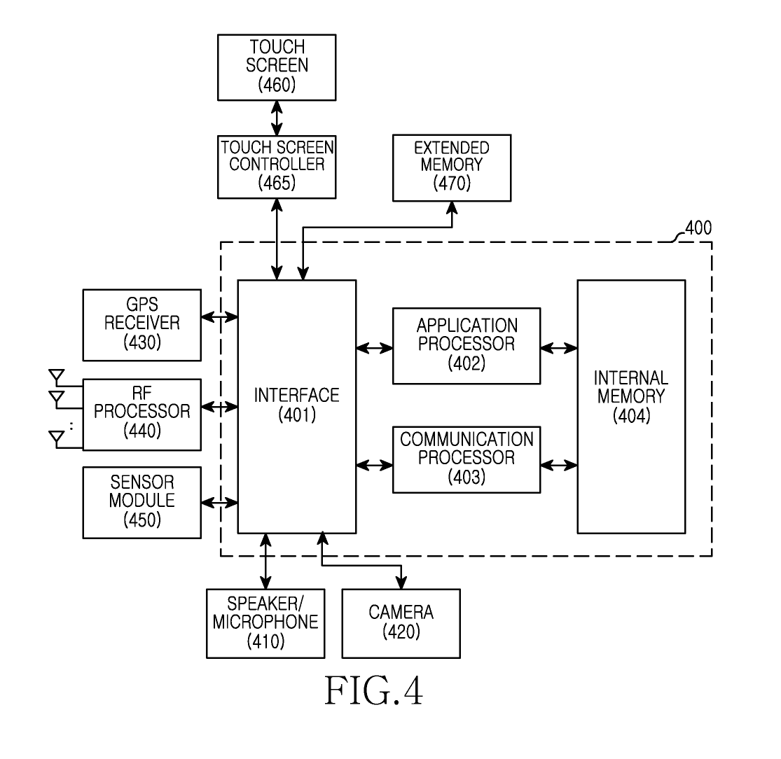

FIG. 4 is a schematic block diagram of an electronic device according to an embodiment of the present disclosure.

The electronic device may be a portable electronic device, such as a portable terminal, a mobile terminal, a mobile pad, a media player, a tablet computer, a handheld computer or a Personal Digital Assistant (PDA).

Referring to FIG. 4, the electronic device includes a controller 400, a speaker/microphone 410, a camera 420, a Global Positioning System (GPS) receiver 430, a Radio Frequency (RF) processor 440, a sensor module 450, a touch screen 460, a touch screen controller 465, and an extended memory 470.

The controller 400 may include an interface 401, one or more processors 402 and 403, and an internal memory 404. In some cases, the controller 400 itself is referred to as a processor. The interface 401, an application processor 402, a communication processor 403, and the internal memory 404 may be separate components or integrated in one or more integrated circuit.

The application processor 402 executes several software programs and performs several functions for the electronic device, and the communication processor 403 performs processing and control for voice and data communication. Moreover, in addition to these typical functions, the processors 402 and 403 execute a specific software module (a set of instructions) that is stored in the extended memory 470 or the internal memory 404, and play a role in performing several specific functions corresponding to the module. For example, the processors 402 and 403 are linked to software modules stored in the extended memory 470 or the internal memory 404 and perform a method of selecting a multi-antenna transmission mode according to the present disclosure.

For example, in order to detect how the user grips the electronic device, the communication processor 403 detects a touch from the touch screen or a signal from the grip sensor, and determines, based on the detected result, whether a user grips the electronic device and which part of the electronic device the user grips. For example, the communication processor 403 determines whether the user grips the upper or lower part of the electronic device. The communication processor 403 determines whether the user grips a part of the electronic device matching or adjacent to an antenna, and if positive, it selects a first transmission mode and determines a master antenna and a slave antenna. For example, when there is an antenna that is affected by a human body, a first transmission mode in which the same data stream is transmitted through two antennas is selected, an antenna that is affected by a human body is set to a slave antenna, and an antenna that is not affected by a human body is set to a master antenna. Here, the master antenna may perform both transmission and reception and the slave antenna may perform transmission.

On the other hand, if the user does not grip a part of the electronic device matching or adjacent to an antenna, the communication processor 403 selects a second transmission mode. For example, when there is no antenna that is affected by a human body, a second transmission mode in which different data streams are transmitted through two antennas is selected.

In addition, the communication processor transmits and receives data according to a corresponding transmission mode. For example, in the first transmission mode, the electronic device transmits the same data stream by using two antennas and in the second transmission mode, the electronic device transmits different data streams by using two antennas.

On the other hand, other processors (not illustrated) may include one or more data processors, an image processor, a codec, or the like. The data processors, the image processor, or the codec may be separately configured. Moreover, other processors may include several processors that perform different functions. The interface 401 is connected to the touch screen controller 465 and the extended memory 470.

The sensor module 450 is coupled to the interface 401 and may thus, perform several functions. For example, a motion sensor and a photo sensor are coupled to the interface 401 and may thus, detect the motion of the electronic device and external light respectively. In addition, a location measuring system and other sensors, such as a temperature sensor or a bio sensor, are connected to the interface 450 and may thus, perform related functions.

In addition, the grip sensor is coupled to the interface 401 and thus, detects a change in pressure or a change in capacitance that corresponds to how the user grips the electronic device. The grip sensor may include may include a resistive touch sensor, a C-type capacitive touch sensor, and a strain gauge sensor. Here, the resistive touch sensor may be defined as a sensor that may recognize coordinates for a change in resistance caused by a user input and detect a change in pressure. Moreover, the C-type capacitive touch sensor may be defined as a sensor that determines coordinates through a change in capacitance that is caused by a user input. Moreover, the strain gauge sensor may be defined as a sensor that may recognize a value in a sensor changed by pressure applied by a user and detect a change in pressure. According to another embodiment, a proximity sensor instead of the grip sensor may be used to recognize how the user grips the electronic device. For example, when a user grips the electronic device with his/her hand, the proximity sensor detects the proximity of an object (such as a user's hand) and outputs a corresponding signal.

The camera 420 may be coupled to the sensor module 450 through the interface 401 and may thus, perform camera functions, such as recording pictures and video clips.

The RF processor 440 performs a communication function. For example, it converts an RF signal into a baseband signal under the control of the communication processor 403 and provides the converted signal to the communication processor 403, or converts and transmits the baseband signal from the communication processor 403 into the RF signal. Here, the communication processor 403 processes a baseband signal in various communication schemes. For example, the communication schemes may include, but are not limited to, Global System for Mobile Communication (GSM) Enhanced Data GSM Environment (EDGE), Code Division Multiple Access (CDMA), W-Code Division Multiple Access (W-CDMA), Long Term Evolution (LTE), Orthogonal Frequency Division Multiple Access (OFDMA), Wireless Fidelity (Wi-Fi), WiMax and/or Bluetooth communication schemes.

The speaker/microphone 410 may be responsible for the input and output of an audio stream, such as voice recognition, voice copy, digital recording, call functions, and the like. For example, the speaker/microphone 410 converts an audio signal into an electrical signal or vice versa. Although not illustrated, a detachable earphone, a head phone or a head set may be connected to the electronic device through an external port.

The touch screen controller 465 may be coupled to the touch screen 460. The touch screen 460 and the touch screen controller 465 may use, without limitation, capacitive, resistive, infrared and Surface Acoustic Wave (SAW) technologies for determining one or more contact points with the touch screen 460 and any multi touch detecting technology including other proximity sensor arrays or other elements to be able to detect contact and motion or the interruption thereof.

The touch screen 460 provides an input/output interface between the electronic device and a user. For example, the touch screen 460 delivers a touch input from a user to the electronic device. Moreover, it is a medium through which an output from the electronic device is shown to a user. For example, the touch screen shows a visual output to a user. Such a visual output is represented by a text, a graphic, a video and combinations thereof.

The touch screen 460 may include several displays. For example, the touch screen 460 may include, but is not limited to, a Liquid Crystal Display (LCD), a Light Emitting Diode (LED), a Light Emitting Polymer Display (LPD), an Organic Light Emitting Diode (OLED), an Active Matrix Organic Light Emitting Diode (AMOLED) or a Flexible LED (FLED).

The GPS receiver 430 converts a signal received from an artificial satellite into location, speed, and time information. For example, the distance between the satellite and the GPS receiver is calculated by multiplying the speed of light by a time when a signal arrives, and the location of the electronic device is measured by using a known triangulation principle after obtaining the accurate locations and distances of three satellites.

The extended memory 470 or the internal memory 404 may include one or more high speed Random Access Memories (RAMs) and/or non-volatile memories, such as magnetic disk storages, or one or more optical storage devices and/or flash memories (for example, NAND, NOR).

The extended memory 470 or the internal memory 404 stores software. Software components include an Operating System (OS) software module, a communication software module, a graphic software module, a user interface software module, a Motion Pictures Expert Group (MPEG) module, a camera software module, and one or more application software modules. Moreover, since the module or software component may be represented as a set of instructions, the module is also represented as an instruction set. The module is also represented as a program.

The OS software includes several software components that control general system operations. These general system operations mean, for example, memory management and control, storage hardware (device) control and management, and power control and management. Such OS software also performs a function of making communication between a lot of hardware (devices) and software components (modules) smooth.

The communication software module may enable communication with other electronic devices, such as a computer, a server and/or a portable terminal, through the RF processor 440. In addition, the communication software module is configured in a protocol structure corresponding to a corresponding communication scheme.

Regarding the present disclosure, the communication software module includes instructions for selecting a multi-antenna transmission mode (see FIG. 2).

For example, in order to detect how the user grips the electronic device, the communication software module detects a touch from the touch screen or a signal from the grip sensor, and determines, based on the detected result, whether a user grips the electronic device and which part of the electronic device the user grips. For example, the communication software module determines whether the user grips the upper or lower part of the electronic device. The communication software module determines whether the user grips a part of the electronic device matching or adjacent to an antenna, and if positive, it selects a first transmission mode and determines a master antenna and a slave antenna. For example, when there is an antenna that is affected by a human body, a first transmission mode in which the same data stream is transmitted through two antennas is selected, an antenna that is affected by a human body is set to a slave antenna, and an antenna that is not affected by a human body is set to a master antenna. Here, the master antenna may perform both transmission and reception and the slave antenna may perform transmission.

Moreover, if the user does not grip a part of the electronic device matching or adjacent to an antenna, the communication software module selects a second transmission mode. For example, when there is no antenna that is affected by a human body, a second transmission mode in which different data streams are transmitted through two antennas is selected.

In addition, the communication software module transmits and receives data according to a corresponding transmission mode. For example, in the first transmission mode, the electronic device transmits the same data stream by using two antennas and in the second transmission mode, the electronic device transmits different data streams by using two antennas.

The graphic software module includes several software components for providing and displaying graphics on the touch screen 460. The term graphics is used as a meaning that includes a text, a web page, an icon, a digital image, a video, and animation.

The user interface software module includes several software components related to the user interface. It includes details on how the state of the user interface is changed or under which condition the state of the user interface is changed.

The camera software module includes camera related software components that enable camera related processes and functions. The application module includes a web browser function including a rendering engine, an email, an instant message, a word processing, a keyboard emulation, an address book, a contact list (touch list), a widget, a Digital Right Management (DRM), a voice recognition, voice copy and position determining functions, and a location based service. The memories 470 and 404 may include additional modules (instructions) in addition to the above-described modules. Alternatively, some modules (instructions) may not be used as needed.

Methods according to various embodiments described in the following claims and/or the specification of the present disclosure may be implemented in hardware, software, or a combination thereof.

In a case where the method is implemented in software, a non-transitory computer readable storage medium that stores one or more programs (software modules) may be provided. The one or more programs that are stored in the computer readable storage medium is configured for execution by one or more processors in the electronic device. The one or more programs include instructions that allow the electronic device to execute the methods according to the various embodiments described in the claims and/or the specification of the present disclosure.

Such programs (software modules or software) may be stored in RAMs, non-volatile memories including flash memories, Read Only Memories (ROM), Electrically Erasable Programmable Read Only Memories (EEPROMs), magnetic disc storage devices, Compact Disc-ROMs (CD-ROMs), Digital Versatile Discs (DVDs), other types of optical storage devices, or magnetic cassette. Alternatively, the programs may be stored in a memory that consists of a combination of some or all thereof. Moreover, each component memory may be included in plural.

Moreover, the programs may be stored in an attachable storage device that is accessible to the electronic device through a communication network, such as the Internet, Intranet, a Local Area Network (LAN), a wide LAN (WLAN), or a Storage Area Network (SAN), or through a communication network consisting of a combination thereof. Such a storage device may access the electronic device through an external port.

Moreover, a separate storage device on a communication network may also access a portable electronic device.

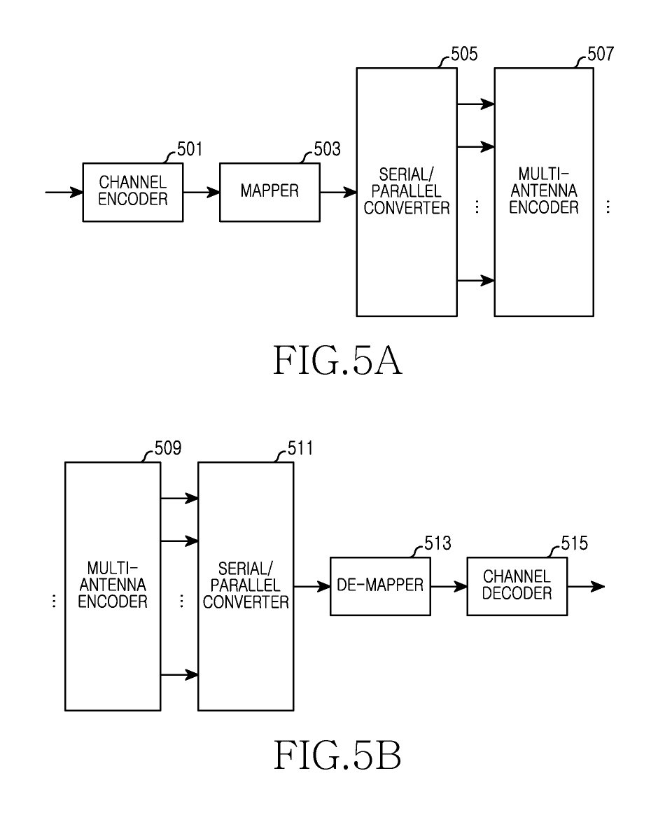

FIGS. 5A and 5B are schematic block diagrams of a communication processor according to an embodiment of the present disclosure.

Referring to FIGS. 5A and 5B, at the transmission terminal, a channel encoder 501 is responsible for playing a role in attaching an additional bit to an information bit and thus, decreasing an impact due to noise, a mapper 503 converts data bit information into data symbol information, a serial-parallel converter 505 is responsible for playing a role in parallelizing a data symbol so as to impress it on a plurality of sub carriers, and a multi-antenna encoder 507 performs mapping between the parallelized data symbol and antennas so that different data streams may be transmitted to transmitting antennas (a spatial multiplexing scheme), or converts the parallelized data symbol into a time-space code (a spatial diversity scheme), according to a transmission mode. Moreover, the multi-antenna encoder 507 converts the parallelized data symbol into a time-space code (a spatial diversity transmission).

The time-space code is a technique in which the same signal is continuously sent in a multi-antenna environment and signals are transmitted through different antennas in repetitive transmission to obtain a reception diversity gain. As the time-space code, a time-space trellis code or a time-space block code may be used.

According to another implementation, the multi-antenna encoder 507 is a scheme in which transmission diversity is obtained based on an open loop mode, and may use Orthogonal Transmit Diversity (OTD), Time Switched Time Diversity (TSTD), Space Time Transmit Diversity (STTD), and Vertical Bell Laboratories Layered Space Time (V-BLAST) schemes. Moreover, a transmission diversity scheme may be used in which based on a closed loop mode, a receiver measures the state of a channel, obtains an optimum transmission weight according to the state of the channel, returns the value to a transmitter, multiplies and transmits the value by a transmission signal.

At the reception terminal, a multi-antenna decoder 509, a parallel-serial converter 511, a de-mapper 513, and a channel decoder 515 perform the inverse functions of the multi-antenna encoder 507, the serial-parallel converter 505, the mapper 503, and the channel encoder 501 of the transmission terminal, respectively.

As describe above, according to whether there is a contact with a human body, a spatial multiplexing scheme is switched to a spatial diversity scheme and thus, the present disclosure has an advantage in that it is possible to minimize a decrease in antenna efficiency according to a contact with a human body.

Moreover, according to whether there is a contact with a human body, the spatial multiplexing scheme is switched to the spatial diversity scheme and thus, it is possible to decrease a load for the switching between the spatial multiplexing scheme and the spatial diversity scheme according to a change in magnetic field.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for selecting a multi-antenna transmission mode in an electronic device, the method comprising:
determining, by using a detection signal from a sensor, whether there is a contact with a human body that affects an electromagnetic field around an antenna;
changing a second transmission mode to a first transmission mode if there is a contact with a human body that affects an electromagnetic field around an antenna; and
transmitting a same data stream through two or more antennas according to the first transmission mode.

2. The method of claim 1, wherein the first transmission mode is a transmission mode of a spatial diversity scheme in which a same data stream is transmitted through the two or more antennas, and
the second transmission mode is a transmission mode of a spatial multiplexing scheme in which different data streams are transmitted through the two or more antennas.

3. The method of claim 1, further comprising setting, to a slave antenna, one of the two antennas that is affected by the contact with a human body, and the other of the two antennas to a master antenna, if there is a contact with the human body that affects the electromagnetic field around the antenna.

4. The method of claim 3, wherein the master antenna performs both transmission and reception and the slave antenna performs just transmission.

5. The method of claim 1, further comprising selecting the second transmission mode of the spatial multiplexing scheme in which different streams are transmitted through the two or more antennas, if there is no contact with the human body that affects the electromagnetic field around the antenna.

6. The method of claim 1, wherein the sensor is a grip sensor, and
wherein the determining, by using the detection signal from the sensor, of whether there is a contact with the human body that affects the electromagnetic field around the antenna comprises:
detecting a change in pressure or in capacitance by using the grip sensor; and
determining that there is a contact with the human body that affects the electromagnetic field around the antenna, if the change in pressure or in capacitance is equal to or greater than a threshold.

7. A method of operating an electronic device, the method comprising:
determining by using a detection signal from a sensor whether there is a contact with a human body that affects an electromagnetic field around an antenna;
selecting a first transmission mode if there is a contact with the human body that affects the electromagnetic field around the antenna, and selecting a second transmission mode if there is no contact with the human body that affects the electromagnetic field around the antenna; and
transmitting a data stream through two or more antennas according to the first or second transmission mode.

8. The method of claim 7, wherein the first transmission mode is a transmission mode of a spatial diversity scheme in which a same data stream is transmitted through the two or more antennas, and wherein the second transmission mode is a transmission mode of a spatial multiplexing scheme in which different data streams are transmitted through the two or more antennas.

9. The method of claim 7, further comprising setting, to a slave antenna, one of the two antennas that is affected by the contact with a human body, and the other of the two antennas to a master antenna, if there is a contact with the human body that affects the electromagnetic field around the antenna.

10. The method of claim 9, wherein the master antenna performs both transmission and reception and the slave antenna performs transmission.

11. The method of claim 7, wherein the sensor is a grip sensor, and
wherein the determining, by using the detection signal from the sensor, of whether there is a contact with the human body that affects the electromagnetic field around the antenna comprises:
detecting a change in pressure or in capacitance by using the grip sensor; and
determining that there is a contact with the human body, if the change in pressure or in capacitance is equal to or greater than a threshold.

12. An electronic device comprising:
a sensor;
one or more processors;
a memory; and
one or more programs stored in the memory and configured to be executed by the one or more processors, wherein the one or more programs comprise instructions to:
determine, by using a detection signal from a sensor, whether there is a contact with a human body that affects an electromagnetic field around an antenna;
change a second transmission mode to a first transmission mode if there is a contact with the human body; and
transmit a same data stream through two or more antennas according to the first transmission mode.

13. The electronic device of claim 12, wherein the first transmission mode is a transmission mode of a spatial diversity scheme in which a same data stream is transmitted through the two or more antennas, and wherein the second transmission mode is a transmission mode of a spatial multiplexing scheme in which different data streams are transmitted through the two or more antennas.

14. The electronic device of claim 12, wherein the one or more programs further comprise an instruction to set, to a slave antenna, one of the two antennas that is affected by the contact with the human body, and the other of the two antennas to a master antenna, if there is a contact with the human body that affects the electromagnetic field around the antenna.

15. The electronic device of claim 14, wherein the master antenna performs both transmission and reception and the slave antenna performs transmission.

16. The electronic device of claim 12, wherein the one or more programs further comprise an instruction to select the second transmission mode of the spatial multiplexing scheme in which different data streams are transmitted through the two or more antennas, if there is no contact with the human body that affects the magnetic field around the antenna.

17. The electronic device of claim 12, wherein the sensor is a grip sensor, and wherein the one or more programs comprise instructions to:
determine, by using the detection signal from the sensor, whether there is a contact with the human body that affects the electromagnetic field around the antenna;
detect a change in pressure or in capacitance by using the grip sensor; and
determine that there is a contact with the human body, if the change in pressure or in capacitance is equal to or greater than a threshold.

18. An electronic device comprising:
a sensor;
one or more processors;
a memory; and
one or more programs stored in the memory and configured to be executed by the one or more processors, wherein the one or more programs comprise instructions to:
determine, by using a detection signal from the sensor, whether there is a contact with a human body that affects an electromagnetic field around an antenna;
select a first transmission mode if there is a contact with the human body that affects the electromagnetic field around the antenna and select a second transmission mode if there is no contact with the human body; and
transmit a data stream through two or more antennas according to the first or second transmission mode.

19. The electronic device of claim 18, wherein the first transmission mode is a transmission mode of a spatial diversity scheme in which a same data stream is transmitted through the two or more antennas, and wherein the second transmission mode is a transmission mode of a spatial multiplexing scheme in which different data streams are transmitted through the two or more antennas.

20. The electronic device of claim 18, wherein the one or more programs further comprise an instruction to set, to a slave antenna, one of the two antennas that is affected by the contact with the human body, and the other of the two antennas to a master antenna, if there is a contact with the human body that affects the electromagnetic field around the antenna.

21. The electronic device of claim 20, wherein the master antenna performs both transmission and reception and the slave antenna performs transmission.

22. The electronic device of claim 18, wherein the sensor is a grip sensor, and wherein the program comprises instructions to:
determine, by using the detection signal from the sensor, whether there is a contact with the human body that affects the electromagnetic field around the antenna;
detect a change in pressure or in capacitance by using the grip sensor; and
determine that there is a contact with the human body, if the change in pressure or in capacitance is equal to or greater than a threshold.
